(19) United States
(12) Patent Application Publication
(10) Pub. No.: US 2006/0178075 A1
(43) Pub. Date: Aug. 10, 2006

(54) Altering chemicals and removing white oxide coating on high-intensity arc lamp for better performance

(75) Inventors: Myron K. Gordin, Oskaloosa, IA (US); Timothy J. Boyle, Oskaloosa, IA (US)

Correspondence Address: MCKEE, VOORHEES & SEASE, P.L.C., 801 GRAND AVENUE, SUITE 3200, DES MOINES, IA, 50309-2721, US

(73) Assignee: MUSCO CORPORATION, Oskaloosa, IA (US)

(21) Appl. No.: 11/333,119

(22) Filed: Jan. 17, 2006

Related U.S. Application Data
(60) Provisional application No. 60/644,687, filed on Jan. 18, 2005.
(60) Provisional application No. 60/644,639, filed on Jan. 18, 2005.
(60) Provisional application No. 60/644,536, filed on Jan. 18, 2005.
(60) Provisional application No. 60/644,747, filed on Jan. 18, 2005.
(60) Provisional application No. 60/644,534, filed on Jan. 18, 2005.
(60) Provisional application No. 60/644,720, filed on Jan. 18, 2005.
(60) Provisional application No. 60/655,688, filed on Feb. 23, 2005.
(60) Provisional application No. 60/644,636, filed on Jan. 18, 2005.
(60) Provisional application No. 60/644,517, filed on Jan. 18, 2005.
(60) Provisional application No. 60/644,609, filed on Jan. 18, 2005.
(60) Provisional application No. 60/644,516, filed on Jan. 18, 2005.
(60) Provisional application No. 60/644,546, filed on Jan. 18, 2005.
(60) Provisional application No. 60/644,547, filed on Jan. 18, 2005.
(60) Provisional application No. 60/644,638, filed on Jan. 18, 2005.
(60) Provisional application No. 60/644,537, filed on Jan. 18, 2005.
(60) Provisional application No. 60/644,637, filed on Jan. 18, 2005.
(60) Provisional application No. 60/644,719, filed on Jan. 18, 2005.
(60) Provisional application No. 60/644,784, filed on Jan. 18, 2005.

(51) Int. Cl. H01J 9/38; H01J 9/00

(52) U.S. Cl. 445/38; 445/26

(57) ABSTRACT

A method of increasing useable light from a high intensity arc lamp without an increase in energy use. In one aspect, the method modifies the conventional HID arc tube by operating it without heat reflective coatings on opposite ends. In another aspect of the invention, the salt pool inside the arc tube is increased. In a further aspect, the arc tube is operated at or near horizontal. These aspects can be used in any combination.

### CROSS-REFERENCE TO RELATED APPLICATIONS

This application claims priority under 35 U.S.C. § 119 of a provisional application U.S. Ser. No. 60/644,639 filed Jan. 18, 2005, which application is hereby incorporated by reference in its entirety. This application is also a non-provisional of the following provisional U.S. applications, all filed Jan. 18, 2005: U.S. Ser. No. 60/644,536; U.S. Ser. No. 60/644,747; U.S. Ser. No. 60/644,534; U.S. Ser. No. 60/644,720; U.S. Ser. No. 60/644,688; U.S. Ser. No. 60/644,636; U.S. Ser. No. 60/644,517; U.S. Ser. No. 60/644,609; U.S. Ser. No. 60/644,516; U.S. Ser. No. 60/644,546; U.S. Ser. No. 60/644,547; U.S. Ser. No. 60/644,638; U.S. Ser. No. 60/644,537; U.S. Ser. No. 60/644,637; U.S. Ser. No. 60/644,719; U.S. Ser. No. 60/644,784; U.S. Ser. No. 60/644,687, each of which is herein incorporated by reference in its entirety.

### INCORPORATION BY REFERENCE

The contents of the following U.S. Patents are incorporated by reference by their entirety: U.S. Pat. Nos. 4,816,974; 4,947,303; 5,161,883; 5,600,537; 5,816,691; 5,856,721; 6,036,338.

### I. BACKGROUND OF THE INVENTION

A. Field of the Invention

The present invention relates to high intensity discharge (HID) lamps, and in particular to HID arc tubes and their operation.

B. Problems in the Art

The patents incorporated by reference herein disclose sports field lighting systems, like those generally illustrated in FIGS. 1A-F. There is room for improvement with such fixtures and how they are operated.

One identified area of improvement is with respect to the HID lamps used with them. FIGS. 3A-C illustrates generally one type of HID lamp. It has a quartz arc tube inside an outer glass envelope. The arc tube typically has white oxide coatings on opposite ends (on the exterior of the quartz tube). There is a mixture of compounds inside the arc tube to assist in generation of light when electricity is applied across the electrodes of the arc tube.

It would beneficial to produce more light per unit electrical energy to operate the arc tube.

### II. SUMMARY OF THE INVENTION

The present invention relates to an HID arc tube light source and method of operating it in an enclosed space such as inside a lamp envelope or globe. An apparatus according to the present invention comprises an arc tube without coatings on the opposite ends. Additionally, the salt compounds inside the arc tube are adjusted to create a larger “pool” of salts than what is presently conventional.

A method according to the present invention operates the apparatus in a horizontal position, or as close to horizontal as possible.

The apparatus and method provide for increased light output per unit input energy. The additional light can be advantageously used. For example, it can reduce the energy costs for operation of the lamp and/or it can provide more useful light for the area to be lighted.

Typical sports lighting systems use a plurality of HID lamps and fixtures. Increased light output per fixture can result in substantial savings for the system.

A. Objects, Features, or Advantages, of the Invention

It is therefore a principal object, feature, or advantage of the present invention to present an apparatus or method, and its incorporation into a lighting system, which improves over or solves certain problems and deficiencies in the art.

Other objects, features, or advantages of the present invention include such a fixture, method, or system which can accomplish one or more of the following:
a) reduce energy use;
b) increase the amount of useable light at each fixture for a fixed amount of energy;
c) more effectively utilize the light produced at each fixture relative to a target area;
d) provide operating methodologies to both reduce operating costs and increase lamp life for each fixture;
e) improve operating characteristics of the fixture;
f) can reduce capital costs for a system by reducing number of fixtures needed for a given target area;

B. Exemplary Aspects of the Invention

An apparatus according to one aspect of the invention comprises a high intensity lighting fixture apparatus with a high intensity discharge (HID) lamp with an arc tube that is altered from conventional HID lamps. An increased metal halide salt pool is added to the chemistry of the arc tube of the lamp. The conventional white oxide coatings at opposite ends of conventional arc tubes are removed.

In another aspect a yoke or other supporting structure in the light fixture is adapted to hold the arc lamp so that its arc tube operates in a horizontal position, or as close as possible thereto, over most conventional operating positions for the fixture. In operation the lamp produces additional lumens for the same electrical energy as a lamp without the altered chemistry, with white oxide coatings, and which is not operated horizontally.

### III. BRIEF DESCRIPTION OF THE DRAWINGS

FIG. 1A and its sub-parts B-F illustrate generally a sports lighting system, and conventional components for a sports lighting system.

FIG. 2A and its sub-parts B-E illustrate a high intensity discharge arc tube according to an embodiment of the present invention.

FIG. 3A and its sub-parts B-C illustrate a high intensity discharge arc lamp that is used with an exemplary embodiment of the present invention.

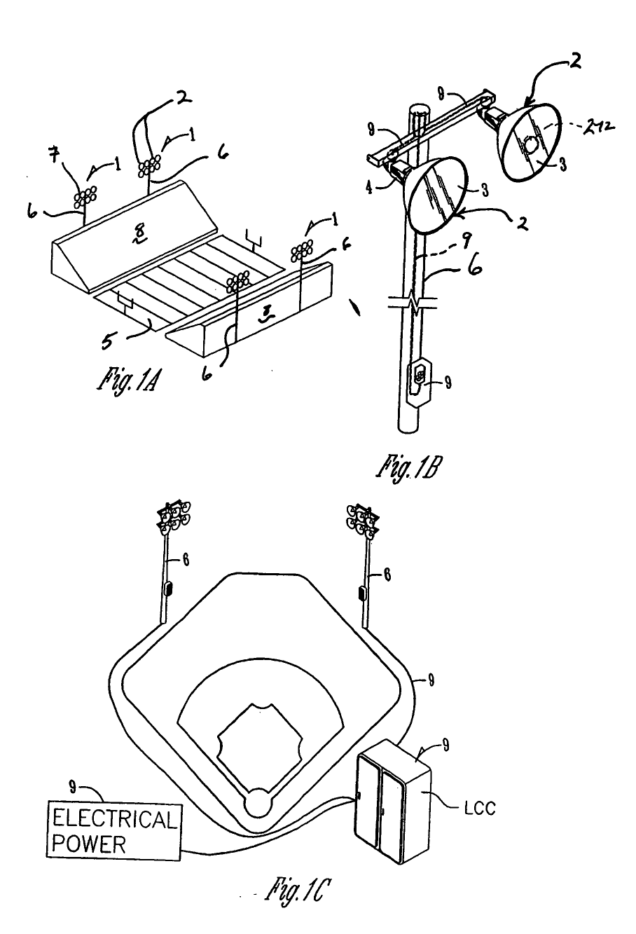

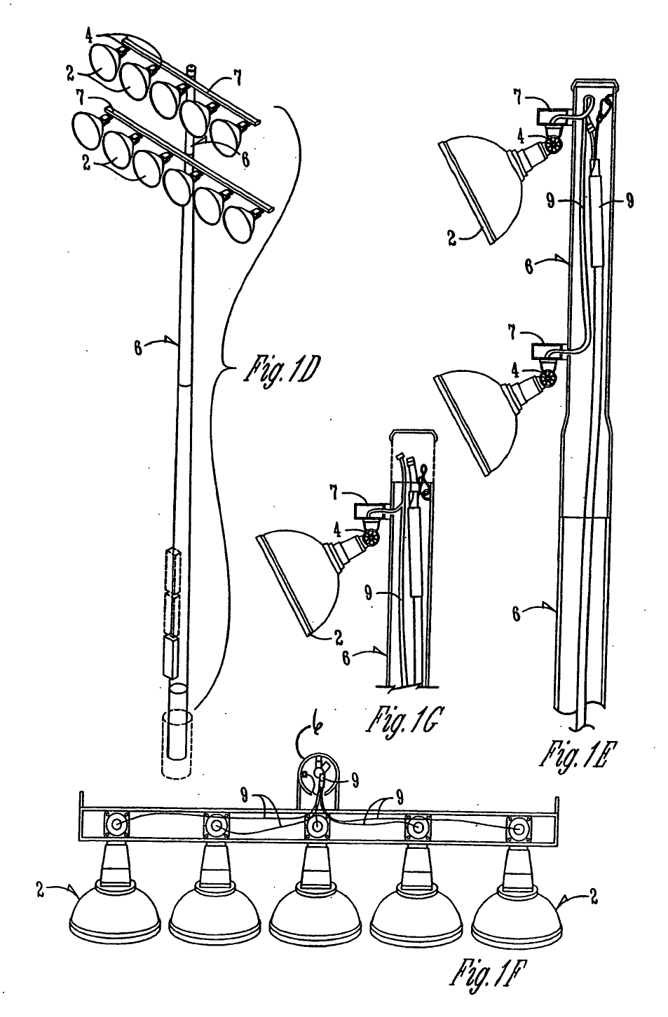

### IV. DETAILED DESCRIPTION OF EXEMPLARY EMBODIMENTS

A. Overview

For a better understanding of the invention, exemplary embodiments will now be described in detail. Frequent reference will be made to the accompanying drawings. Reference numerals and letters will be used to indicate certain parts and locations in the drawings. The same reference numerals or letters will be used to indicate the same parts and locations throughout the drawings unless otherwise indicated.

B. Exemplary Apparatus

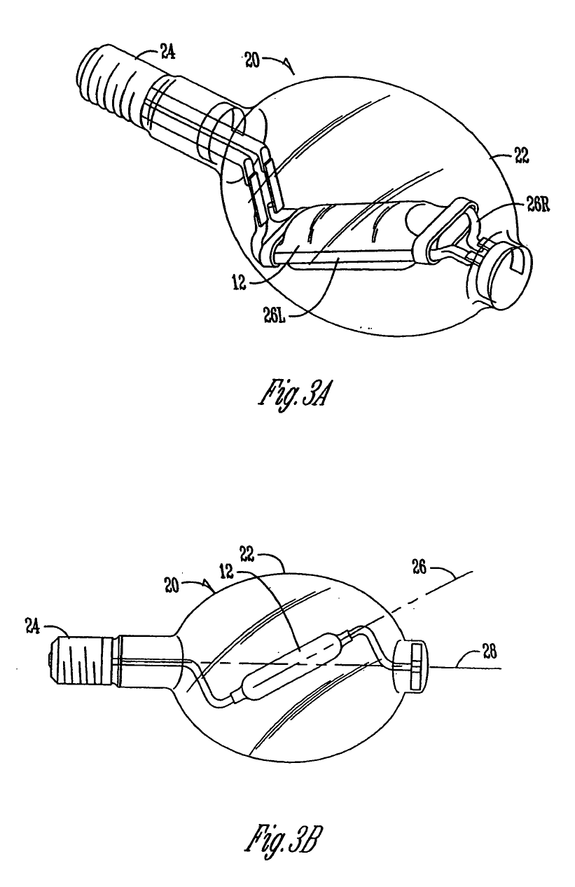

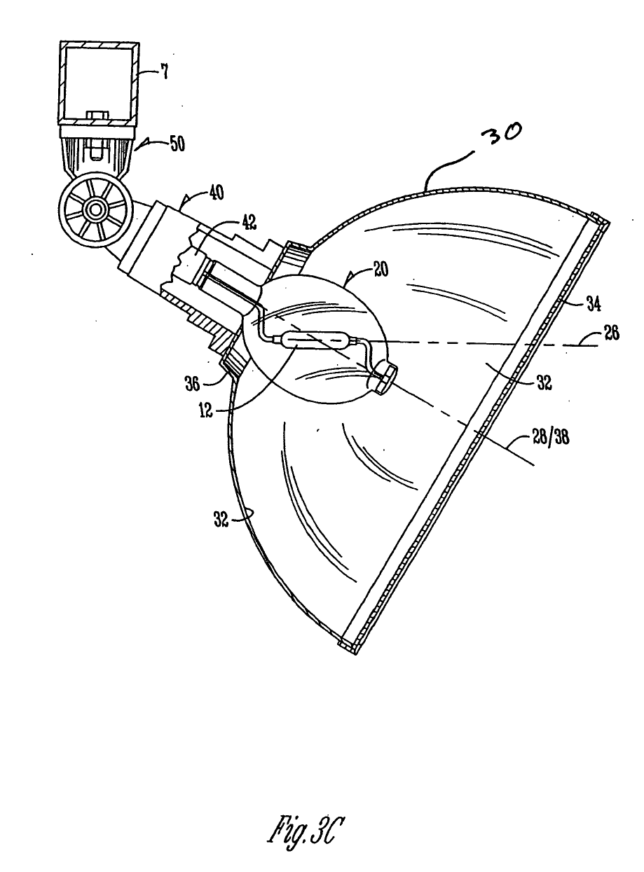

Arc lamp 20 is of the general type disclosed in Musco Corporation U.S. Pat. No. 5,856,721, incorporated by reference herein, with certain modifications. These types of lamps are used by Musco Corporation under the trademark Z-Lamp™ and typically are 1000 watt or greater metal halide (MH) HID lamps. Its arc tube 12 is tilted obliquely across the longitudinal axis of the arc lamp 20 (see FIGS. 3A-C). In operation, it is rotationally positioned in fixture 10 such that the longitudinal axes of the arc tube (reference 26 in FIG. 3C) and the lamp (reference 28/38 in FIG. 3C) define a vertical plane, and the longitudinal axis 26 of arc tube 12 is as close to a horizontal plane as possible.

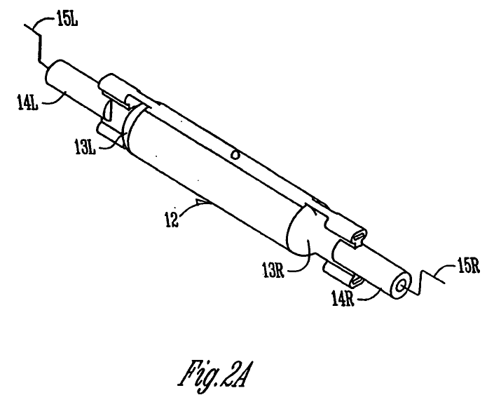

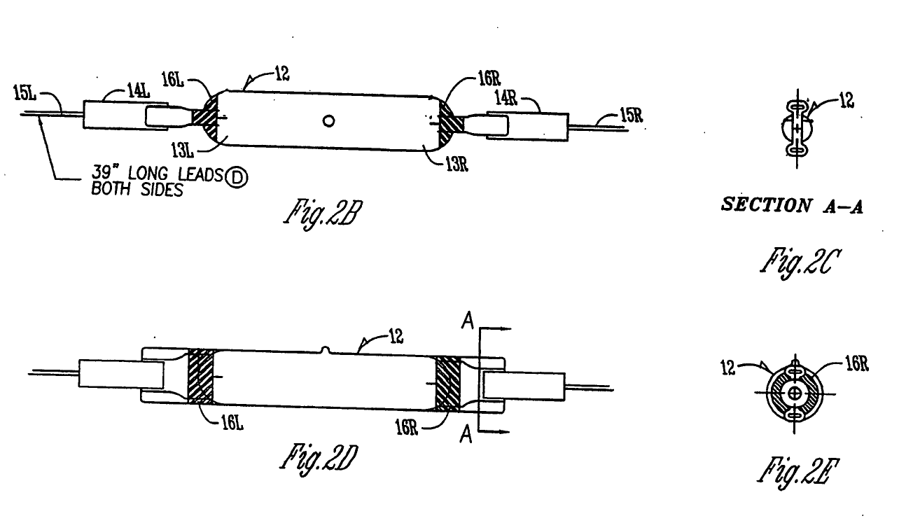

Conventional HID lamps for sports lighting have white oxide coatings around opposite ends of the arc tube (see cross-hatched areas of FIGS. 2B-E). As illustrated in FIG. 2A (by the absence of cross-hatching), arc tube 12 of lamp 20 is modified to leave off or remove the conventional white oxide coatings 16L and 16R from its opposite ends 13L and 13R.

In conventional metal halide ED lamps, including those used for sports lighting, light is generated in a high-pressure mercury discharge to which other light-emitting species are added to improve the spectrum of the lamp. See, W. van Erk, “Transport processes in metal halide gas discharge lamps”, Pure Appl. Chem., Vol. 72, No. 11, pp. 2159-2166, 2000, which is incorporated by reference herein. Some of these other light-emitting species are sodium-scandium mixtures, sometimes called metal halide salts. Arc tube 12 of metal halide lamp 20 of this exemplary embodiment is modified to have an increased amount of the sodium-scandium salt mixture pool. It is approximately doubled over that of conventional HID lamps of this type. For example, one 2,000 watt HID metal halide lamp for sports lighting conventionally has approximately 31 milligrams of such salts. This is increased to approximately 61 milligrams. This provides a bigger “salt pool” over operation life of the lamp. The increased amount is added during manufacturing by the same methods used to add conventional amounts.

C. New Lamp Lumens by Reduction of Tilt Factor

It has been determined that additional lumen output can be achieved by holding the arc tube 12 horizontal during operation of lamp 20.

One form of lamp 20 offsets the arc tube axis 26 from lamp axis 28 by a fixed amount (e.g. 30°). This is a frequent aiming angle for sports lighting fixtures. As noted previously, however, rarely do all fixtures for a field end up aimed exactly 300 below horizontal. As described in U.S. Pat. No. 5,856,721, and as can be appreciated by those skilled in the art, lamp 20 would decrease the amount of tilt factor over normal sports lighting aiming angles because it will be closer to horizontal than conventional lamps over normal sports lighting angles. Therefore, it would represent in most cases a net increase in lumen output over the life of the lamp for a given energy input.

There are other ways to adjust the relationship between the arc tube 12 and the aiming axis of the reflector surface 32. Reference is taken to Musco Corporation U.S. Pat. No. 5,161,883, incorporated by reference herein. Here fixture 10 includes an automatic horizontal leveling of the arc tube over a normal range of aiming angles for the fixture. The lamp position is retained independent of the lamp cone over a range of conventional sports lighting aiming angles for the cone (e.g. 15 degrees up to 60 degrees down relative to horizontal). This automatic total tilt factor correction feature eliminates the lumen depreciation caused by tilt factor. It also provides the added advantage of allowing a single type of HID lamp to be used in most, if not all, the fixtures for the given lighting application, even though many of the fixtures will be aimed at different angles relative the target field.

Care must be taken to ensure arc tube 12 of lamp 20 ends up in a rotational orientation so that the longitudinal axis of arc tube 12 and the longitudinal axis of arc lamp 20 are in a vertical plane during operation. This requires the correct rotational orientation of the Z-Lamp™ in its socket. This can be done manually by screwing or locating it appropriately when installing. Alternatively, there can be structure(s) to help ensure this (see Musco U.S. Pat. No. 5,161,883—disclosing a pin on the base of lamp 20 that fits in a helical slot in socket 154 to determine rotational alignment of lamp 20). Fixture 10 could also include the further feature of correction slots or other structure to rotational adjust the socket holding lamp 20 for at least miner adjustment, e.g. either as the sole means or in case the pin/slot arrangement is not precise or there is other misalignment.

D. New Lamp Lumens by Removal of Conventional Arc Tube End Coatings

It has been discovered that if an arc tube can be operated at or closely horizontal, omission of the normal white oxide coating on opposite ends of the arc tube and increase of the sodium-scandium salt pool can increase lumen output of an HID lamp, at least at some part of its operating life. An increase in lumen output is expected.

Conventionally such white oxide coatings are used to try to keep the ends of the arc tube heated to deter cooler locations which can lead to precipitation of chemicals and reduction in lumen output. It has been discovered that they can be eliminated in many or most situations and there is reduced lamp lumen depreciation for the HID lamp later in its operating life. Lamp lumen depreciation, as used here and as well-known in the art, refers to the loss of lumen output experienced by HID lamps as they accumulate operating hours. The reduced lumen depreciation of modified arc tube 12 has been found to begin to have substantial effect after the initial rapid lumen depreciation period (usually the first 100 hours or so of lamp operation). Therefore, just elimination of the white oxide coatings and the increased salt pool could produce additional lumens for the same input energy. However, it has also been found that removal of the coatings results in more severe and quicker tilt factor. Tilt factor, as used here and as well-known in the art, relates to loss of lumen output if certain HID lamps (metal halide included) are operated at other than vertical or horizontal. Therefore, horizontal operation of arc tube 12 could avoid such reduction of light gains caused by this potentially enhanced tilt factor.

E. New Lamp Lumens by Alteration of Conventional Arc Tube Chemistry

Over time, as these types of lamps age, some of the salts migrate through the quartz of the arc tube, especially at higher temperatures. Some of the chemicals attack the quartz and sacrifice. This can reduce the lumen output or affect the performance of the arc tube and shorten its life.

By creating the bigger “salt pool” it has been discovered that it at least keeps the lumen output higher (reduces lumen depreciation over operating hours of the lamp). Furthermore, by running the arc lamp horizontal, it does not heat up one end or the other (and deters precipitation of chemicals at a cooler spot which can occlude the tube and block useable light) and is believed to reduce migration of the salts through the quartz, attack of the quartz by the salts, or loss of the salts. Also, it has been found that that not only will lumen output increase during operation of the lamp, the lamp will run cooler. This decreases risk of lamp failure by extrusion of the chemicals through the quartz of arc tube 12, which risk is higher at higher temperatures. It contributes to longer life for the arc lamp. The aesthetic performance of the lamp is also maintained, if not improved, providing the right mix of light frequencies for sports lighting.

The altered chemistry, removal of arc tube end coatings, and horizontal operation will cumulatively improve performance of lamp 20 (efficiency of the lamp and aesthetic performance), increase lamp lumens, and increase lamp life. This bigger “salt pool” is believed to contribute to increased lumen output at least during certain periods during the operating life of the lamp.

It is believed the above-described changed lamp chemistry can make any HID lamp more effective, but at least, that the increase of the salt pool will be effective on different metal halide chemistries that are conventional.

F. Options and Alternatives

It will be appreciated that the foregoing exemplary embodiment is given by way of example only and not by way of limitation. Variations obvious to those skilled in the art will be included in the invention. The scope of the invention is defined solely by the claims.

For example, variations in dimensions, materials, and combinations are contemplated by the invention. In particular, all of the features and aspects of the exemplary embodiment are not required to produce a beneficial or advantageous result.

What is claimed is:

1. A method for increasing useable light from a high intensity arc lamp without an increase in energy use, the lighting fixture including an arc tube substantially surrounded by a glass envelope, comprising:
a. increasing lamp lumen output without an increase in operating energy by using a high intensity discharge lamp with an arc tube that is operated:
i. without heat reflective coatings on either end;
ii. with an increased metal halide salt pool;
iii. at or near horizontal.

2. The method of claim 1 wherein the salt pool is increased by approximately double.

3. The method of claim 1 further comprising automatically maintaining the arc tube at or near horizontal regardless of orientation of the lighting fixture.

4. The method of claim 1 further comprising utilizing an arc lamp with an arc tube offset from the longitudinal axis of the lamp, and mounting the lamp relative to the lighting fixture so that the arc tube is at or near horizontal in the operating position for the lighting fixture.

5. The method of claim 4 further comprising including an automatic locating system to ensure the correct rotational position of the arc tube relative its mount to the lighting fixture to ensure it is at or near horizontal when the lighting fixture is in operating position.

6. The method of claim 1 wherein the heat reflective coatings are white oxide coatings.

7. A method for improving useable light from a high intensity arc lamp without an increase in energy use, the arc lamp being of the type having an arc tube with a salt pool and heat reflected coatings on either end of the arc tube, the improvement comprising:
a. removing the heat reflective coating.

8. The method of claim 7 further comprising increasing the salt pool in the arc tube.

9. The method of claim 7 further comprising operating the arc tube at or near horizontal.

10. A lighting fixture comprising:
a. a lighting fixture housing with a mount for a high intensity discharge arc lamp;
b. the high intensity discharge arc lamp comprising an arc tube without heat reflective coatings on either end and an increased salt pool.

11. The apparatus of claim 10 wherein the increased salt pool comprises approximately doubling the salt pool of a conventional version of the arc lamp.

12. The apparatus of claim 10 further comprising orienting the arc tube relative to the fixture such that it will operate at or near horizontal at the aiming angle of the fixture.

13. The apparatus of claim 10 further comprising an apparatus to adjust the relative orientation of the lamp to the fixture over a range of aiming angles of the fixture relative of a target area.

14. A method for increasing useable light from a high intensity arc lamp without an increase in energy use, the lighting fixture including an arc tube substantially surrounded by a glass envelope, comprising:
a. increasing lamp lumen output without an increase in operating energy by using a high intensity discharge lamp with an arc tube that is operated:
i. without heat reflective coatings on either end.

15. A method for increasing useable light from a high intensity arc lamp without an increase in energy use, the lighting fixture including an arc tube substantially surrounded by a glass envelope, comprising:
a. increasing lamp lumen output without an increase in operating energy by using a high intensity discharge lamp with an arc tube that is operated:
i. without heat reflective coatings on either end;
ii. with an increased metal halide salt pool.

16. A method for increasing useable light from a high intensity arc lamp without an increase in energy use, the lighting fixture including an arc tube substantially surrounded by a glass envelope, comprising:
a. increasing lamp lumen output without an increase in operating energy by using a high intensity discharge lamp with an arc tube that is operated:
i. with an increased metal halide salt pool.
